(19) United States
(12) Patent Application Publication
(10) Pub. No.: US 2022/0229705 A1
(43) Pub. Date: Jul. 21, 2022

(54) GEO-REPLICATED SERVICE MANAGEMENT

(71) Applicant: Microsoft Technology Licensing, LLC, Redmond, WA (US)

(72) Inventors: Jeet Sunil MODY, Redmond, WA (US); Anindit KARMAKAR, Redmond, WA (US)

(21) Appl. No.: 17/150,279

(22) Filed: Jan. 15, 2021

(51) Int. Cl. G06F 9/50; G06N 20/00; G06K 9/62

(52) U.S. Cl. CPC G06F 9/5077; G06F 9/5072; G06F 2209/502; G06K 9/6223; G06F 2209/505; G06N 20/00

(57) ABSTRACT

Embodiments automatically identify which cloud resources and resource groups correspond to which geo-replicated services and service replicas. Resource groups are represented as vectors having features which may depend on resource types, resource group tags, resource group names, and other data. Vectors are clustered using hierarchical agglomerative clustering, for example, and each cluster is recognized as corresponding to a service. Associations between resources and services are then used for management functions such as updating or testing or suspending or modifying only the resources of a given service, finding configuration inconsistencies, or identifying higher cost replicas. Because two replicas of a given service may have different resource configurations or different constituent resources, similarity measures may be employed to map resources between replicas when defining resource group vectors or analyzing replicas. Automation permits documentation of accurate current associations between resources and services, even when resources are being created or deleted automatically.

### BACKGROUND

Geo-replication increases the distribution of cloud-based services or data across geographically distributed locations. Geo-replication may be done to promote data redundancy that aids business continuity or disaster recovery. The risk of data becoming lost completely or being unavailable too long is reduced by keeping copies of data in different locations that are unlikely to be simultaneously threatened by the same natural disaster, network slowdown, electrical failure, or human conflict. Keeping data closer to a wide range of separate locations also tends to improve service responsiveness at each of those locations. Software-as-a-service providers and cloud service providers may use geo-replication to help satisfy service level agreements and other performance requirements.

### SUMMARY

Some embodiments automatically determine which cloud-based resources correspond to a given geo-replicated service. In some cases, resources are assigned to resource groups but it is not readily apparent which resource groups belong to which geo-replicated service, so an embodiment uses unsupervised machine learning clustering to determine likely associations. In some situations, differently configured resource groups nonetheless belong to the same geo-replicated service, so similarity mappings between resources are computed to help determine likely associations. After associations of resources or resource groups with geo-replicated services are determined, then configuration consistency checks, performance monitoring, and other service management actions are facilitated. Additional geo-replicated service management tools and techniques are also described herein.

Some embodiments use or provide a computing hardware and software combination which includes a digital memory, and a processor which is in operable communication with the memory. The processor is configured, e.g., by tailored software, to perform steps for geo-replicated service management. The embodiment identifies at least one resource group in each of a plurality of cloud regions, each resource group including at least one cloud resource. The embodiment represents each resource group as a vector in a predefined feature vector space, and clusters similar resource group vectors by use of unsupervised machine learning, thereby producing clusters which span cloud regions. Each cluster contains at least one resource group vector. The embodiment forms digital associations which associate geo-replicated services with clusters, and supplies the digital associations to a service management tool. Thus, the embodiment supports effective management of at least one geo-replicated service whose respective cloud resources were not previously expressly identified as belonging to that geo-replicated service.

Some embodiments use or provide steps for geo-replicated service management. The steps may include: identifying at least one resource group in each of a plurality of cloud regions, each resource group including at least one cloud resource; automatically representing each resource group as a digital vector in a predefined feature vector space; automatically clustering similar resource group vectors by use of unsupervised machine learning, thereby producing clusters which span cloud regions, each cluster containing at least one resource group vector; automatically forming digital associations which associate geo-replicated services with clusters; and utilizing at least one of the digital associations to manage at least one geo-replicated service.

Some embodiments use or provide a computer-readable storage medium configured with data and instructions, or use other computing items, which upon execution by a processor cause a computing system to perform a method for geo-replicated service management. This method includes: identifying a resource group in each of a plurality of cloud regions, each resource group including a plurality of cloud resources; automatically representing each resource group as a digital vector in a predefined feature vector space; automatically clustering similar resource group vectors, thereby producing a cluster which spans at least two cloud regions, the cluster containing at least two resource group vectors; automatically forming a digital association which associates a geo-replicated service with the cluster; and utilizing the digital association to manage the geo-replicated service.

Other technical activities and characteristics pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims as properly understood, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating computer systems generally and also illustrating configured storage media generally;

FIG. 2 is a block diagram illustrating a computing system equipped with geo-replicated service management functionality, and some aspects of a surrounding environment;

FIG. 3 is a block diagram further illustrating a computing system equipped with geo-replicated service management functionality;

FIG. 4 is a block diagram illustrating some aspects of clustering;

FIG. 5 is a block diagram illustrating some examples of vector space features;

FIG. 6 is a block diagram illustrating some aspects of cloud-based resources;

FIG. 7 is a block diagram illustrating some aspects of geo-replicated services;

FIG. 8 is a symbolic diagram wherein cloud-based resources are depicted as geometric shapes, and cloud regions containing the resources are also shown using dashed vertical lines;

FIG. 9 is a refinement of FIG. 8, in which some resource groups are identified by round-cornered rectangles, with each rectangle surrounding the shapes that represent the resources belonging to a respective resource group;

FIG. 10 is a refinement of FIG. 9, in which some resource group clusters are identified by numbered arcs, with each set of one or more like-numbered arcs and the resource groups connected by that arc set belonging to a respective cluster;

FIG. 11 is a flowchart illustrating steps in some geo-replicated service management methods; and

FIG. 12 is a flowchart further illustrating steps in some geo-replicated service management methods.

### DETAILED DESCRIPTION

### Overview

Innovations may expand beyond their origins, but understanding an innovation's origins can help one more fully appreciate the innovation. In the present case, some teachings described herein were motivated by technical challenges faced by Microsoft innovators who were working to improve the usability, efficiency, and effectiveness of Microsoft cloud offerings, including versions of Microsoft cloud app management tools, e.g., an Azure® Application Change Analysis tool (mark of Microsoft Corporation). Teachings herein also apply to other cloud software environments, applications, and tools. Teachings herein may be applied to provide insights to cloud customers that can help them improve the performance and stability of their cloud-based services.

The Azure® cloud currently supports dozens of geographic regions, including one or more regions in each of the following: Australia, Brazil, Canada, China, France, Germany, India, Japan, Korea, Norway, South Africa, Switzerland, United Arab Emirates, United Kingdom, and United States, with more expected. A “region” in a cloud is defined in the industry by the cloud's provider. A cloud-based service may be implemented using software or data or both that resides in one or more regions. When a service is implemented in at least two cloud regions, the service is said to be “geo-replicated”. A region of a geo-replicated service does not necessarily correspond to a legal region such as a country or province; hence, regions may have names such as “Australia Central 2” or “West Central US” or “Southeast Asia”.

Although a list of the cloud-based resources (virtual machines, virtual networks, machine learning models, databases, storage space, etc.) that are owned by a given cloud subscriber may be readily available, that subscriber may also have many geo-replicated services. The association between a given geo-replicated service and its resources, or between a given resource and its geo-replicated service, if any, is not automatically available to the subscriber.

Manually maintaining a list of which cloud-based resources belong to which geo-replicated service would be tedious and error-prone even for relatively small and static service implementations. Manual list maintenance would not be feasible in a cloud environment in which resources are routinely allocated, deployed, configured, updated, and deallocated proactively and automatically. In production systems, situations involving hundreds of resource groups and thousands of individual resources located in a dozen or more regions are not unusual. In addition, a replica implementation may change faster than any person could keep up; after all, one of the primary advantages of clouds is their ability to rapidly and automatically scale resources up or down to meet changing demands. Manual resource-service association list maintenance would also be hampered in that not every resource necessarily belongs to a geo-replicated service, and not every service is necessarily a geo-replicated service.

In view of the foregoing, some embodiments described herein help enhanced tools, or human administrators, as they manage geo-replicated services. The embodiments assist management by automatically determining resource-service associations, using clustering or mapping algorithms, or both. For example, resource groups may be represented by vectors (“vectorization”), and the vectors may then be clustered through unsupervised machine learning, thereby producing a cluster of resource group vectors which corresponds to a cluster of resource groups that spans two or more cloud regions (in the region-or-availability-zone-or-both sense, per a “region” definition herein). Thus, a resource group cluster corresponds to a geo-replicated service, with each resource group in the cluster corresponding to a replica of that geo-replicated service.

Once the correspondence is determined between resource groups (and their constituent resources) on the one hand and a geo-replicated service, on the other hand, is determined, service management operations are enabled. For example, one may calculate the operational cost of a service as the sum of operational costs of the service's constituent resources. Likewise, one may fully suspend execution of a service by suspending execution of all of the service's constituent resources. Other management operations may also be enabled.

Thus, a technical challenge faced by the innovators was to how to automatically and efficiently associate a resource with its geo-replicated service, or associate a geo-replicated service with its resources. One emergent subsidiary challenge was how to represent resource groups in a vector space. Another technical challenge was how to assess the similarity of non-identically configured or constituted resource groups. One of skill will recognize these and other technical challenges as they are addressed at various points within the present disclosure.

### Operating Environments

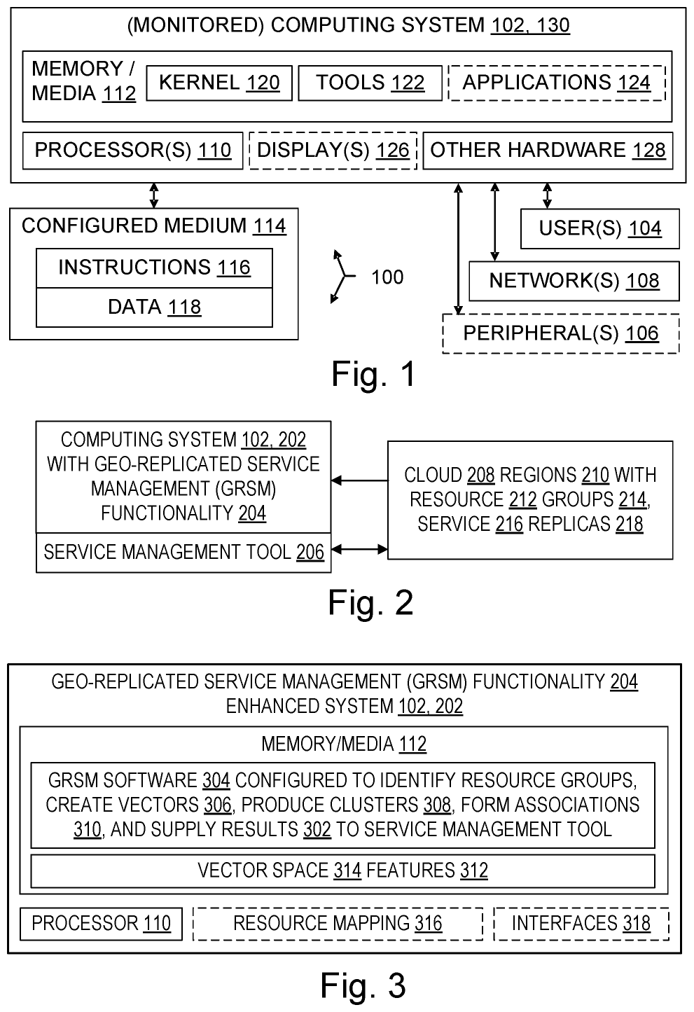

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud. An individual machine is a computer system, and a network or other group of cooperating machines is also a computer system. A given computer system 102 may be configured for end-users, e.g., with applications, for administrators, as a server, as a distributed processing node, and/or in other ways.

Human users 104 may interact with the computer system 102 by using displays, keyboards, and other peripherals 106, via typed text, touch, voice, movement, computer vision, gestures, and/or other forms of I/O. A screen 126 may be a removable peripheral 106 or may be an integral part of the system 102. A user interface may support interaction between an embodiment and one or more human users. A user interface may include a command line interface, a graphical user interface (GUI), natural user interface (NUI), voice command interface, and/or other user interface (UI) presentations, which may be presented as distinct options or may be integrated.

System administrators, network administrators, cloud administrators, security analysts and other security personnel, operations personnel, developers, testers, engineers, auditors, and end-users are each a particular type of user 104. Automated agents, scripts, playback software, devices, and the like acting on behalf of one or more people may also be users 104, e.g., to facilitate testing a system 102. Storage devices and/or networking devices may be considered peripheral equipment in some embodiments and part of a system 102 in other embodiments, depending on their detachability from the processor 110. Other computer systems not shown in FIG. 1 may interact in technological ways with the computer system 102 or with another system embodiment using one or more connections to a network 108 via network interface equipment, for example.

Each computer system 102 includes at least one processor 110. The computer system 102, like other suitable systems, also includes one or more computer-readable storage media 112. Storage media 112 may be of different physical types. The storage media 112 may be volatile memory, non-volatile memory, fixed in place media, removable media, magnetic media, optical media, solid-state media, and/or of other types of physical durable storage media (as opposed to merely a propagated signal or mere energy). In particular, a configured storage medium 114 such as a portable (i.e., external) hard drive, CD, DVD, memory stick, or other removable non-volatile memory medium may become functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se or mere energy under any claim pending or granted in the United States.

The storage medium 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by backup, restore, commits, aborts, reformatting, and/or other technical operations.

Although an embodiment may be described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processors 110 (e.g., CPUs, ALUs, FPUs, TPUs and/or GPUs), memory/storage media 112, and displays 126, an operating environment may also include other hardware 128, such as batteries, buses, power supplies, wired and wireless network interface cards, for instance. The nouns “screen” and “display” are used interchangeably herein. A display 126 may include one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which may be present in a given computer system. Virtualizations of networking interface equipment and other network components such as switches or routers or firewalls may also be present, e.g., in a software-defined network or a sandboxed or other secure cloud computing environment. In some embodiments, one or more computers are partially or fully “air gapped” by reason of being disconnected or only intermittently connected to another networked device or remote cloud or enterprise network. In particular, functionality for geo-replicated service management could be installed on an air gapped network and then be updated periodically or on occasion using removable media. Raw data such as resource IDs and types, and resource group definitions and metadata (e.g., tags, names, cloud region locations) could be loaded onto the air gapped system; service management steps such as vectorization and cluster formation do not dictate continuous connection of the service management system to a cloud. A given embodiment may also communicate technical data and/or technical instructions through direct memory access, removable nonvolatile storage media, or other information storage-retrieval and/or transmission approaches.

One of skill will appreciate that the foregoing aspects and other aspects presented herein under “Operating Environments” may form part of a given embodiment. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but may interoperate with items in the operating environment or some embodiments as discussed herein. It does not follow that items not in outline or parenthetical form are necessarily required, in any Figure or any embodiment. In particular, FIG. 1 is provided for convenience; inclusion of an item in FIG. 1 does not imply that the item, or the described use of the item, was known prior to the current innovations.

### More About Systems

FIGS. 2 through 7 illustrate an environment having an enhanced system 202, 102 that includes functionality 204 for geo-replicated service management (GRSM). In some embodiments, the GRSM functionality 204 is divided between different machines 102, while on others the GRSM functionality 204 resides on a single machine 102.

In some embodiments, the GRSM functionality 204 supports a service management tool 206 in one or more cloud regions 210, by obtaining or analyzing service-related data 118, 302. The service management tool 206 monitors computing infrastructure, monitors application 124 performance, automates replica 218 creation and deployment, manages resources 212, deploys virtual machine scale sets, analyzes application 124 usage, updates virtual machines, performs fault recovery in a cloud 208, or performs other operations that support or improve or monitor the use of resources 212 or resource groups 214 or geo-replicated services 216 or any combination thereof.

In some embodiments, the GRSM functionality 204 is implemented in a system 102 enhanced with GRSM software 304. This configures the system 102 into an enhanced system 202 which identifies resource groups 214, creates vectors 306 based on the resource groups 214, produces clusters 308 based on the vectors 306, and then forms associations 310 in the form of digital data structures associating at least one resource 212 with a geo-replicated service 216 as a resource 212 of that service 216. The vectors 306 have features 312 and belong to a predefined vector space 314.

Some embodiments compare the configuration of one replica 218 with another replica 218, by comparing the respective groups' resources 212 and their configurations. For instance, one replica may have seven virtual machines handling a distributed workload where another replica has only three virtual machines, or one replica's virtual machines may be allocated two gigabytes of RAM each while another replica's virtual machines were allocated four gigabytes each. In the case of resource groups 214 that may have different configurations, a similarity-based mapping 316 may be used to determine or to verify that two non-identically configured or constituted resource groups 214 correspond to replicas 218 of the same geo-replicated service 216 as one another.

The associations 310 and other analysis results 302 may be supplied to the service management tool 206, e.g., as a data stream, file, network packets, procedure parameters, or by other digital computational mechanism. In addition to associations 310, analysis results may include, e.g., a list of resources or resource groups which are not (at least per the analysis) presently associated with any geo-replicated service, or a description of configuration differences detected between respective replicas 218 of a given geo-replicated service.

Machines or processes within an enhanced system 202 may be networked generally or communicate in particular (via network or otherwise) with one another and with external devices (e.g., management consoles) through one or more interfaces 318. An interface 318 may include hardware such as network interface cards, software such as network stacks, APIs, or sockets, combination items such as network connections, or a combination thereof.

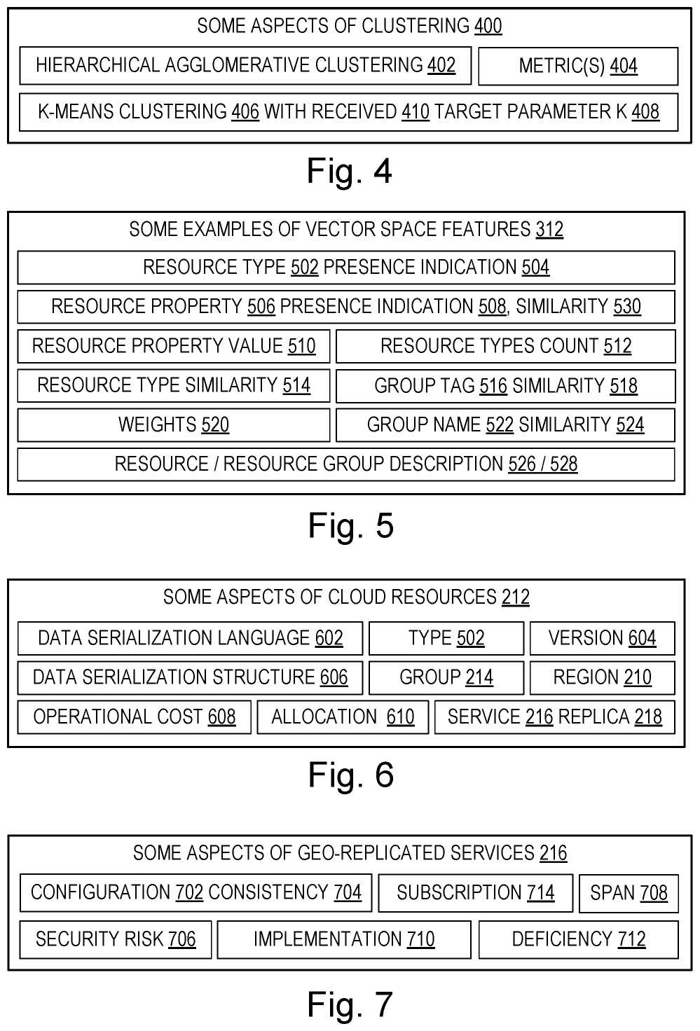

FIG. 4 illustrates several aspects of clustering 400. FIG. 5 illustrates some examples of vector space features 312. FIG. 6 illustrates some aspects of cloud resources 212. FIG. 7 illustrates some aspects of geo-replicated services 216. These items are discussed at various points herein, and additional details regarding them are provided in the discussion of a List of Reference Numerals later in this disclosure document.

### Example Regions, Resources, Resource Groups, and Clusters

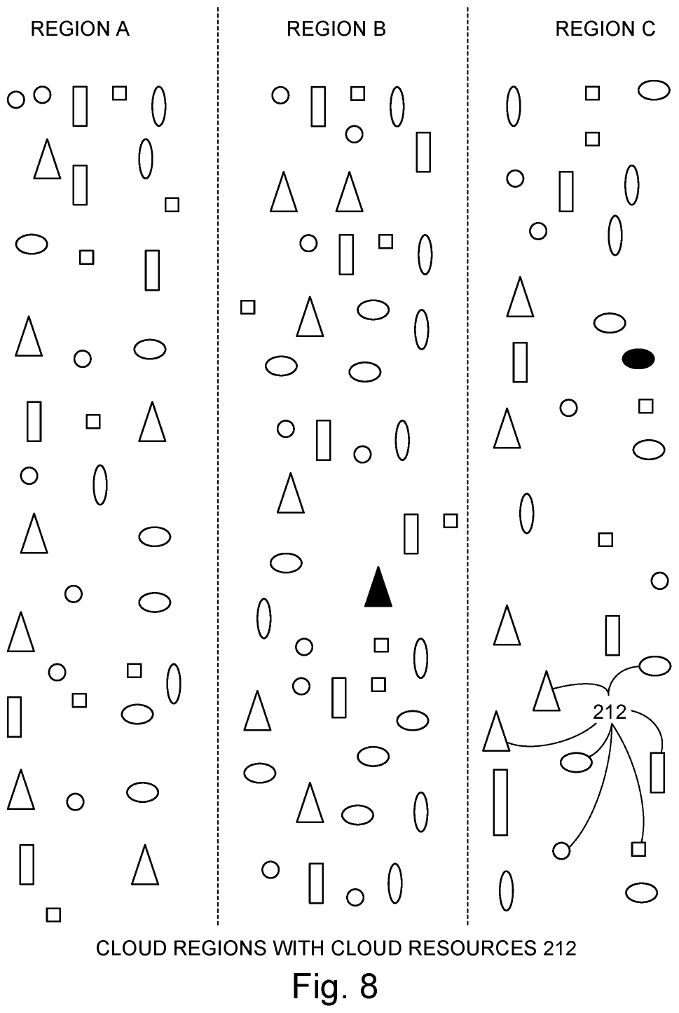

FIGS. 8, 9, and 10 illustrate resources 212, resource groups 214, clusters 308, regions 210, and associations 310. For clarity of illustration, FIGS. 8, 9, and 10 depict the presence or absence of different kinds of resources and how those resources are grouped or clustered or located, for example, rather than listing specific implementation details such as the underlying hardware and installed software and assigned IP addresses and RAM block and other technical details that would be present in an actual physical cloud environment.

FIG. 8 shows three regions 210 with respective resources 212 that are depicted as simple geometric shapes. For clarity of illustration, only some of the many resources depicted show lead lines to an instance of reference numeral 212. Also for clarity, only circles, squares, rectangles, triangles, and ellipses are shown, with each shape indicating a respective type 502 of resource 212; in an actual cloud many more than five types of resources would likely be present. Likewise, only three regions are shown but more than three regions 210 are sometimes used by a given cloud subscriber.

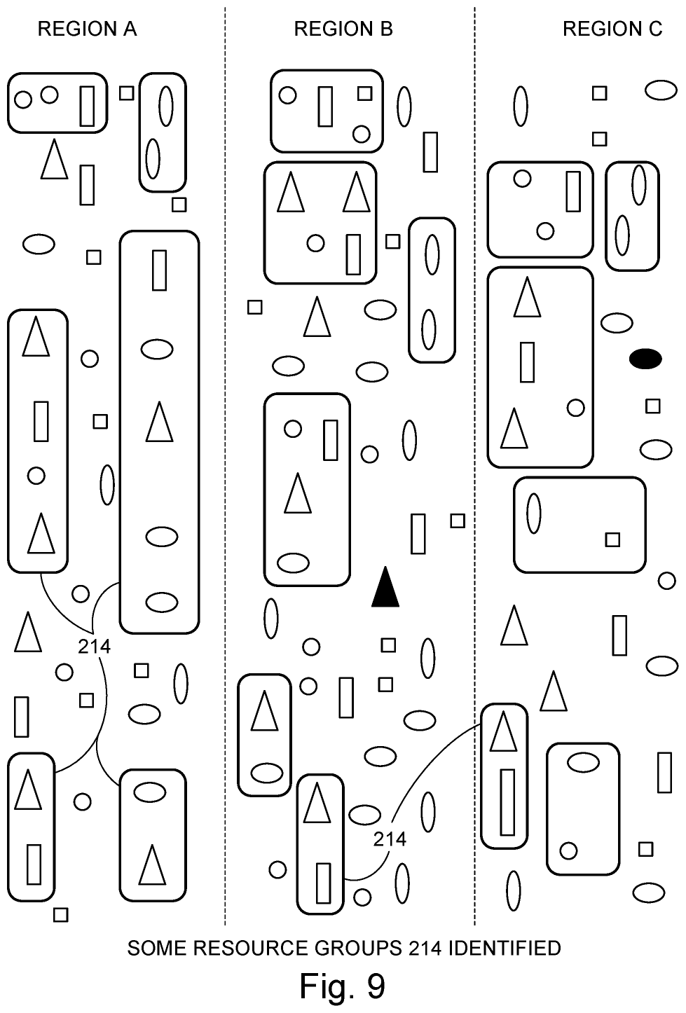

FIG. 9 shows some resources 212 gathered into resource groups 214, which are illustrated as rounded corner rectangles. For clarity of illustration, only some of the resource groups are shown with lead lines to an instance of reference numeral 214. In some embodiments, every resource 212 will belong to exactly one resource group 214, which may be formed by default when the resource is created. In other embodiments, a given resource does not necessarily belong to any resource group, although every resource 212 will belong to some owner, e.g., to another resource that created it or to a cloud subscriber or to the cloud service provider infrastructure.

Most of the resource shapes are shown as outlines in FIGS. 8-10, but one triangle resource in Region B and one ellipse resource in Region C are filled in. This is done to illustrate that resources 212 of the same type 502 may have different properties 506. For example, two resources that are both of the virtual machine type may differ in that one has a single-sign-on-token property and the other does not, or one has a geographic-regulatory-compliance property and the other does not, or one may be inside a virtual network but the other might not, or they may have other property differences. Properties 506 may be considered part of a resource's configuration 702, both as to their presence or absence, and as to their specific values 510.

In some embodiments, storage 112 allocation sizes are considered part of a configuration or a property, while in others they are not. Most of the resource rectangle shapes shown in FIGS. 8-10 are the same size, but two rectangles of different sizes are also shown, to illustrate that two resources of the same type may have different allocations 610. For example, two resources of virtual machine type may have different disk storage allocations, or different RAM allocations, or both. The two differently sized rectangles that are shown in order to illustrate the possibility of different allocations are most easily located by looking at FIG. 9. Region B and Region C each include, near the bottom of FIG. 9, a respective resource group 214 containing a triangle and a rectangle, which represent resources 212 of two different types 502. The rectangle resource in the Region C group 214 is larger than the rectangle resource in the Region B group, illustrating the possibility of different allocation sizes 610.

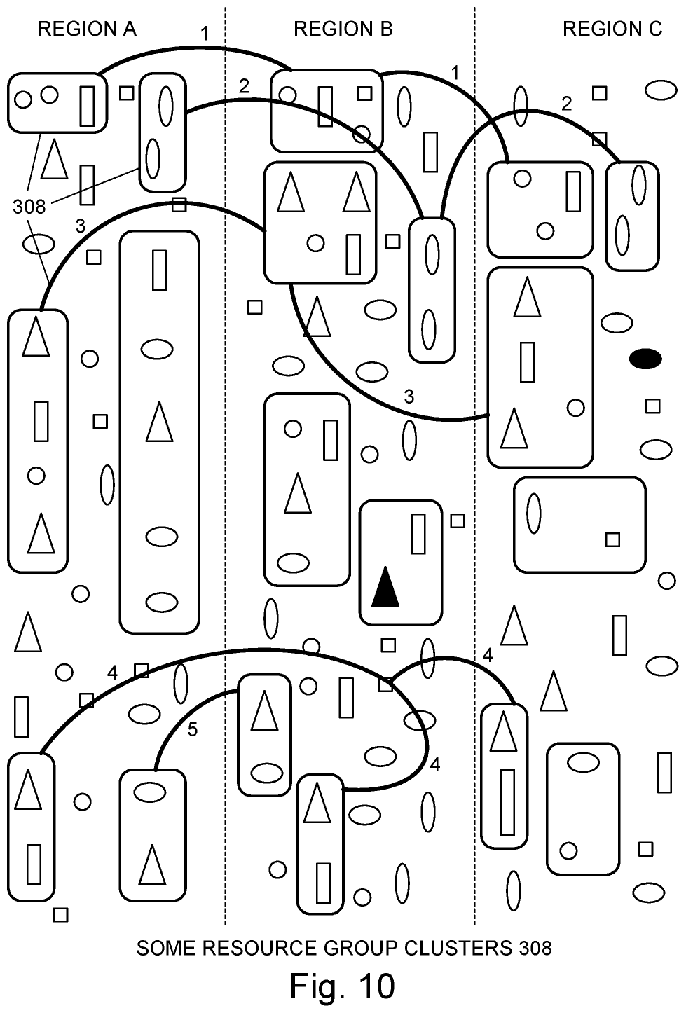

FIG. 10 shows five clusters 308 of resource groups 214, numbered 1 through 5, respectively. Each cluster 308 includes two or more resource groups 214 (shown as resource shapes within a round-cornered rectangle) connected by one or more arcs that are numbered with the cluster number. Cluster number 1, cluster number 2, cluster number 3, and cluster number 4 each include three respective resource groups and each span regions A, B, and C. Cluster number 5 includes two resource groups and spans regions A and B. For clarity of illustration, only three of the clusters are shown with lead lines to an instance of reference numeral 308.

To illustrate the possibility of configuration differences between replicas of a geo-replicated service 216, in FIG. 10 cluster 1 (corresponding to service 1) has a cluster group (corresponding to a replica) in Region B which has a square resource type that is not present in the cluster 1 cluster groups in Regions A and C. For example, the Region B resource group may have a log resource that the other groups lack.

To illustrate the possibility that not every service is a geo-replicated service, FIG. 10 also shows several resource groups that are not part of any cluster. These include one resource group in Region A, two resource groups in Region B, and two resource groups in Region C. The Region A resource group contains a rectangle, a triangle, and three ellipses, to illustrate that a resource group 214 may include multiple resources 212 of the same type 502.

### Example System Embodiments

Some embodiments use or provide a functionality-enhanced system, such as system 202 or another system 102 that is enhanced as taught herein. In some embodiments, a system 202 configured for geo-replicated service management includes a digital memory 112. A processor 110 is in operable communication with the memory 112. The processor is configured, e.g., with software 304, to perform geo-replicated service management steps which include (a) identifying at least one resource group 214 in each of a plurality of cloud regions 210, each resource group including at least one cloud resource 212, (b) representing each resource group as a vector 306 in a predefined feature vector space 314, (c) clustering similar resource group vectors by use of unsupervised machine learning, thereby producing clusters 308 which span cloud regions, each cluster containing at least one resource group vector, (d) forming digital associations 310 which associate geo-replicated services with clusters, and (e) supplying the digital associations to a service management tool 206, thereby supporting effective management of at least one geo-replicated service 216 whose respective cloud resources were not previously expressly identified as belonging to that geo-replicated service.

In some embodiments, the predefined feature vector space 314 includes at least one of the following features 312: a presence indication 504 of a resource of a given type 502 in a resource group, a presence indication 508 of a resource property 506, a resource property value 510, a count 512 of distinct types of resources in a resource group, a resource group tag 516, a resource group name 522, or a resource description 526 or a resource group description 528.

In some embodiments, at least one cloud resource is represented digitally in the system 202 by at least one of the following: a data serialization language 602, or a data serialization structure 606.

In some embodiments, the digital associations 310 associate geo-replicated services 216 with clusters 308 such that each cluster includes at most one resource group 214 per region 210. For example, FIG. 10 shows clusters which each have at most one resource group 214 per region 210. However, other situations may also benefit from teachings herein, e.g., situations in which a cluster associated with a service 216 has N (N>1) resource groups in a given region corresponds to the service 216 having N replicas 218 in that region.

In some embodiments, the digital associations 310 associate geo-replicated services 216 with clusters 308 such that each cluster corresponds to exactly one geo-replicated service, and the system 202 is free of any geo-replicated service 216 which has been expressly identified as a geo-replicated service on a display 126 of the system and which has no associated cluster. Other situations may indicate, for example, that the clustering is not fully accurate, or that a given resource group has been inadvertently affiliated with two different services 216, or that a service 216 has not been given any resources.

Other system embodiments are also described herein, either directly or derivable as system versions of described processes or configured media, duly informed by the extensive discussion herein of computing hardware. Examples are provided in this disclosure to help illustrate aspects of the technology, but the examples given within this document do not describe all of the possible embodiments. An embodiment may depart from the examples. For instance, items shown in different Figures may be included together in an embodiment, items shown in a Figure may be omitted, functionality shown in different items may be combined into fewer items or into a single item, items may be renamed, or items may be connected differently to one another. A given embodiment may include or utilize additional or different numbers of resources, numbers of regions, resource configurations, resource groupings, resource types, resource properties, technical features, operational sequences, data structures, or cloud functionalities for instance, and may otherwise depart from the examples provided herein.

### Processes (a.k.a. Methods)

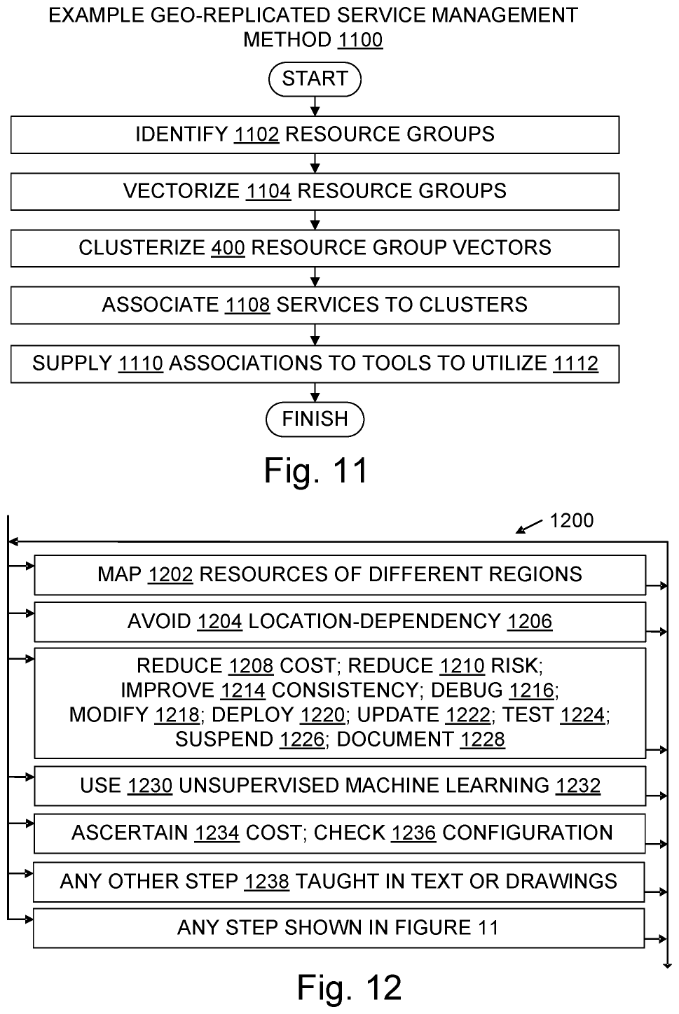

FIG. 11 illustrates a family of methods 1100 that may be performed or assisted by a given enhanced system, such as any system 202 example herein or another functionality 204 enhanced system as taught herein. FIG. 12 further illustrates geo-replicated service management methods. FIG. 12 incorporates all steps shown in FIG. 11. Methods 1100 or 1200 may also be referred to as geo-replicated service management “processes” in the legal sense of the word “process”.

Technical processes shown in the Figures or otherwise disclosed will be performed automatically, e.g., by an enhanced system 202 or software component thereof, unless otherwise indicated. Processes may also be performed in part automatically and in part manually to the extent activity by a human person is implicated. For example, in some embodiments a human may enter an expected number of geo-replicated systems, whereupon the system performs k-means clustering 406 with that expected number of geo-replicated systems as the target number 408 of clusters 308 to produce. But no process contemplated as innovative herein is entirely manual.

In a given embodiment zero or more illustrated steps of a process may be repeated, perhaps with different parameters or data to operate on. Steps in an embodiment may also be done in a different order than the top-to-bottom order that is laid out in FIGS. 11 and 12. Steps may be performed serially, in a partially overlapping manner, or fully in parallel. In particular, the order in which flowchart 1100 or flowchart 1200 operation items are traversed to indicate the steps performed during a process may vary from one performance of the process to another performance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim.

Some embodiments use or provide a method for managing geo-replicated services in one or more clouds, including automatically: identifying 1102 at least one resource group in each of a plurality of cloud regions, each resource group including at least one cloud resource; representing 1104 each resource group as a digital vector in a predefined feature vector space; clustering 400 similar resource group vectors by use 1230 of unsupervised machine learning 1232, thereby producing 400 clusters which span cloud regions 210, each cluster containing at least one resource group vector 306; forming 1108 digital associations 310 which associate geo-replicated services with clusters; and utilizing 1112 at least one of the digital associations to manage at least one geo-replicated service 216.

In some embodiments, utilizing 1112 at least one of the digital associations to manage at least one geo-replicated service includes at least one of the following: reducing 1208 a service operational cost 608; reducing 1210 a service security risk 706; improving 1214 a service configuration consistency 704; debugging 1216 a service deficiency 712; documenting 1228 a service implementation 710; modifying 1218 a service resource allocation 610; modifying 1218 a service regions span 708; suspending 1226 a service 216; deploying 1220 a service 216; updating 1222 a service 216; or testing 1224 a service 216. Service management may be done at the level of the service 216 overall, at a resource group 214 (replica 218) level, or at an individual resource 212 level.

Some embodiments include mapping 1202 from a resource of a service in one region to another resource of the service in another region. In some, the mapping 1202 avoids 1204 reliance on any location-dependent resource property 1206 or location-dependent resource property value 1206. Location-dependent resource properties such as region name are expected to be different between replicas, so they are not used as keys. In some embodiments, the mapping 1202 depends on at least one of the following: a computed measure of similarity 514 between resource types 502; a computed measure of similarity 530 between resource properties 506; or a computed measure of similarity 524 between resource group names 522.

In some embodiments, clustering 400 similar resource group vectors by use 1230 of unsupervised machine learning 1232 includes hierarchical agglomerative clustering 402. However, some embodiments get 410 a target number of services, and then clustering similar resource group vectors by use of unsupervised machine learning 1232 includes K-means clustering 406 with a parameter K 408 that equals the target number of services. For instance, a user may assert that five services should be present, and request details of the current resource groups for some, or all, of those five services 216.

In some embodiments, the digital associations associate 1108 geo-replicated services 216 with clusters 308 such that at least one cluster includes more than one resource group in at least one region. That is, teachings herein may be advantageously applied even when a service has more than one replica in a region. A given service might have more than one replica inside a region to handle additional load, or to provide failure recovery redundancy, for example.

In some embodiments, utilizing 1112 a digital association 310 to manage 1100 at least one geo-replicated service includes at least one of the following: ascertaining 1234 a service operational cost 608, or checking 1236 a service configuration 702. Some embodiments normalize costs in order to compare costs across replicas.

Some embodiments test 1224 at least one digital association 310 for accuracy. For example, clustering 400 done by hierarchical agglomeration 402 which produces N clusters may be tested by performing K-means clustering 406 with parameter K 408 set to N, to test whether the same clusters 308 are produced each time. Testing 1224 may include running only a single service 216 at a time, with monitoring or log analysis to see which resources 212 are accessed while a given service is active. Users 104 may also assess clustering accuracy, as they may recognize some of the resource groups or some of the geo-replicated services, or both.

### Configured Storage Media

Some embodiments include a configured computer-readable storage medium 112. Storage medium 112 may include disks (magnetic, optical, or otherwise), RAM, EEPROMS or other ROMs, and/or other configurable memory, including in particular computer-readable storage media (which are not mere propagated signals). The storage medium which is configured may be in particular a removable storage medium 114 such as a CD, DVD, or flash memory. A general-purpose memory, which may be removable or not, and may be volatile or not, can be configured into an embodiment using items such as GRSM software 304, associations 310, vectors 306, clusters 308, resource mappings 316, and metrics 404, in the form of data 118 and instructions 116, read from a removable storage medium 114 and/or another source such as a network connection, to form a configured storage medium. The configured storage medium 112 is capable of causing a computer system 102 to perform technical process steps for geo-replicated service management, as disclosed herein. The Figures thus help illustrate configured storage media embodiments and process (a.k.a. method) embodiments, as well as system and process embodiments. In particular, any of the process steps illustrated in FIG. 11 or 12 or otherwise taught herein, may be used to help configure a storage medium to form a configured storage medium embodiment.

Some embodiments use or provide a computer-readable storage medium 112, 114 configured with data 118 and instructions 116 which upon execution by at least one processor 110 cause a computing system to perform a method for managing geo-replicated services in one or more clouds. This method includes: identifying 1102 a resource group 214 in each of a plurality of cloud regions 210, each resource group including a plurality of cloud resources 212; automatically representing 1104 each resource group as a digital vector 306 in a predefined feature vector space 314; automatically clustering 400 similar resource group vectors, thereby producing a cluster 308 which spans at least two cloud regions, the cluster containing at least two resource group vectors; automatically forming 1108 a digital association 310 which associates a geo-replicated service 216 with the cluster 308; and utilizing 1112 the digital association to manage the geo-replicated service.

In some embodiments, the method further includes mapping 1202 from a resource of a service in one region to another resource of the service in another region. The resource groups in which the mapped resources reside may have the same configuration as each other, or they may differ. In the FIG. 10 scenario, for example, after a mapping 316 is performed 1202 from the resources of cluster 5 in Region A to the resources of cluster 5 in Region B, an embodiment may determine that each resource has the same configuration as its mapped counterpart (those particular ellipse resource configurations being the same, and those particular triangle resource configurations also being the same), and that no resources in the relevant resource groups remain unmapped. On the other hand, mapping the cluster 1 Region A resources (circle, circle, rectangle) to the cluster 1 Region B resources (circle, circle, rectangle, square) leaves the square resource unmapped. That is, mapping 120 may reveal that two replicas 218 of a given service 216 have different constituent resources 212. More generally, in some embodiments a mapping 316 documents a configuration difference between two or more replicas 218 of a geo-replicated service 216, with each replica corresponding to a respective resource group 214 whose resources 212 are mapped 316 by the mapping 1202.

In some embodiments, the clustering 400 depends on at least a computed measure 404 of similarity between vectors 306 having features 312 which include at least a resource type dependent feature (e.g., resource type presence indication 504 or resource types count 512 or resource type similarity 514) and a resource group tag dependent feature (e.g., resource group tag similarity 518 or tag presence or tag count).

In some embodiments, the computed measure of similarity between vectors gives greater weight 520 to the resource type dependent feature than to the resource group tag dependent feature. This is illustrated elsewhere herein in a formula for Final Similarity, in which a Type Similarity has a weight of 4 but a Tag Similarity has a weight of only 2.

### Technical Character

The technical character of embodiments described herein will be apparent to one of ordinary skill in the art, and will also be apparent in several ways to a wide range of attentive readers. Some embodiments address technical activities such as vectorizing 1104 cloud resource groups, clustering 400 vectors 306, cloud resource mapping 1202, forming digital associations 310 between clusters 308 and geo-replicated services 216, and executing cloud 208 service management tools 206, each of which is an activity deeply rooted in computing technology. Some of the technical mechanisms discussed include, e.g., service management tools 206, geo-replicated service management functionality 204, vector spaces 314, clustering algorithms 402, 406, and cross-region resource mappings 316. Some of the technical effects discussed include, e.g., automatic correlation of cloud resources 212 with geo-replicated services 216, detection of inconsistent cloud service replica configurations 702, identification of resources 212 which have not been assigned to a service 216 and identification of services 216 which have no assigned resources 212, and enablement 1112 of service management at the level of a selected geo-replicated service's resources 212 and resource groups 214. Thus, purely mental processes are clearly excluded. Other advantages based on the technical characteristics of the teachings will also be apparent to one of skill from the description provided.

### Additional Examples and Observations

One of skill will recognize that not every part of this disclosure, or any particular details therein, are necessarily required to satisfy legal criteria such as enablement, written description, or best mode. Any apparent conflict with any other patent disclosure, even from the owner of the present innovations, has no role in interpreting the claims presented in this patent disclosure. With this understanding, which pertains to all parts of the present disclosure, some additional examples and observations are offered.

The following observations, examples, and implementation details are offered regarding metrics 404 which may be applied for clustering 400 or mapping 1202 or both, and some similarities 514, 518, 524 whose computed results may serve as or contribute to distances produced by metrics 404.

Some embodiments identify geo-replicated services in one or more clouds 208. Identifying geo-replicated services 216 and their replicas 218 can be useful in various ways, e.g., to proactively find differences in configurations 702 amongst replicas 218, to perform cost 608 analysis for replicas, and to compare performance across replicas in terms of risks 706 or deficiencies 712.

One pattern of implementing geo-replicated services 216 is to deploy each replica 218 with its own resource group 214; for present purposes, replicas 218 and resource groups 214 may be treated as equivalent when the scope of interest is geo-replicated services 216.

Some embodiments determine which resource groups collectively identify a geo-replicated service, given the subscription ID(s) 714 of the resource groups 214 or the individual resources 212. A naïve approach would be to ask the user which resource groups identify a geo-replicated service. However, there can be many geo replicas 218 of a service, as some clouds support dozens of regions 210. So, asking the user to manually track and enter such a large number of resource group IDs is error-prone, and tedious, especially as resources may be frequently and fully automatically created or removed.

Some embodiments automate identification of service-to-resource-group correlations 310 using an unsupervised machine learning clustering technique known as Hierarchical Agglomerative Clustering (HAC) 402. In such embodiments, the user is not required to provide any inputs identifying the resource groups 214 or the individual resources 212. An embodiment can implement a GRSM service 304 that automatically runs in the background to find all geo-replicated services 216 and their respective replicas 218, resource groups 214, resources 212, and regions 210.

One advantage of such automation is that it enables a cloud 208 infrastructure to find all groupings and then proactively analyze the data for the user. Analysis may disclose red flag situations. For example, analysis software 304 may report to a user something like “The cost of your resource group in location Z is significantly more than the cost of your resource groups in location A, location B, location C and location D.” Or the analysis software 304 may report something like “Your VM in location Z is configured to be 32 bit while your VM in location A, location B, and location C are set to 64 bit.”

To perform HAC, some embodiments represent each resource group 214 of a subscription 714 by a set of features 312. For example, features 312 used may include a count 512 of distinct types of resources in the resource group, any tags 516 on the resource group, and the name 522 of the resource group itself. In addition, these embodiments define a metric 404 to compute similarity between any two resource groups as represented by their feature sets, i.e., as vectors 306 in a vector space 314 having the specified features 312.

Resource type similarity 514 may be used when computing distances to perform clustering 400. In some embodiments, Type Similarity 514 conforms with the following. Suppose one has two resource groups, denoted here as Rg1 and Rg2, having resource types 502 as shown:

Rg1:=[N_{T2}, N_{T2}, N_{T3}, . . . , N_{Tk}]

Rg2:=[M_{T1}, M_{T2}, M_{T3}, . . . , M_{Tk}]

where,

Tk denotes the k-th type of resource.

N_{Tk} and M_{Tk} denotes the count of resources of k-th type in resource group 1 and resource group 2 respectively.

Then resource type similarity 514 may be calculated as:

$$TypeSimilarity = \frac{{\sum }_{i} {N}_{T i} \times {M}_{T i}}{\sqrt{{\sum }_{i} {( {N}_{T i} )}^{2}} \times \sqrt{{\sum }_{i} {( {M}_{T i} )}^{2}}}$$

For example, suppose a Resource Group A contains two virtual machines, one Contoso database, one LitWare database, and one virtual network, and suppose that a Resource Group B contains three virtual machines, one LitWare database, and one virtual network (Contoso and LitWare are fictional companies here). Then these two resource groups may be represented as:

RgA:=[2,1,1,1]

RgB:=[3,0,1,1]

Here, k is 4 as there are 4 types of resources in this universe: a virtual machine type, a Contoso database type, a LitWare database type, and a virtual network type. A different implementation could group all databases as a single type, yielding three types of resources.

Then resource type similarity 514 may be calculated as:

$$TypeS i m ilarity = \frac{( 2 \times 3 ) + ( 0 \times 1 ) + ( 1 \times 1 ) + ( 1 \times 1 )}{( \sqrt{{2}^{2} + {1}^{2} + {1}^{2} + {1}^{2}} ) \times ( \sqrt{{3}^{2} + {0}^{2} + {1}^{2} + {1}^{2}} )} = \frac{8}{\sqrt{7} \times \sqrt{11}} \approx 0.91$$

Resource group tag similarity 518 may be used when computing distances to perform clustering 400. In some embodiments, Tag Similarity 518 conforms with the following. Suppose one has two resource groups, denoted here as Rg1 and Rg2, having tags 516 in the form of key-value pairs as shown:

Rg1:=[Key1:Value1A, Key2:Value2A, . . . , Keyi:ValueiA]

Rg2:=[Key1:Value1B, Key2:Value1B, . . . , Keyj:ValuejB]

Then resource tag similarity 518 may be calculated as:

$$TagSimilarity = \frac{No . of keys with same values between Rg 1 and Rg 2}{No . of unique keys in Rg 1 and Rg 2}$$

For example, suppose a Resource Group A has the following tags (as key-value pairs)

| Key | Value |
|---|---|
| CostCenter | APJ |
| Env | Production |
| Team | Compliance |
| Dept | Finance |

Also, suppose a Resource Group B has the following tags (as key-value pairs):

| Key | Value |
|---|---|
| CostCenter | EMEA |
| Env | Production |
| Team | HumanResources |
| Status | Normal |

Then the resource tag similarity 518 may be calculated as:

Tag Similarity=⅕≈0.2

There is only 1 key with the same value in both Resource Group A and B. There are 5 total unique keys−CostCenter, Env, Team, Dept, Status.

Resource group name similarity 524 may be used when computing distances to perform clustering 400. In some embodiments, a Name Similarity 524 is calculated as follows. First, remove all non-alphanumeric characters from the resource groups' names. Second, remove all strings that denote a specific region (e.g. “eastus”, “westus” or the like). Third, compute a Jaro-Winkler Similarity Score for the resulting strings.

Some embodiments combine individual similarity scores to produce a final similarity score, which is then used as a clustering metric. In some embodiments, for example, a Final Similarity Score is computed as:

$$FinalSimilarity = \frac{4 \times TypeS i m i l a r i t y + 2 \times TagSi m i l a r i t y + 1 \times NameS i m i l a r i t y}{7}$$

These are merely examples. For a given embodiment or a given workload (e.g., production workload), formulas may be tweaked, and features may be added or removed.

Some embodiments define a linkage criterion as a Nearest Neighbor criterion. Some define a threshold to cut a dendrogram at a desired level, e.g., some cut the dendrogram at a similarity score of 0.9. However, the cut level may be tuned after testing it on more datasets. After cutting the dendrogram, each resulting cluster 308 represents a grouping of all replicas of a specific service 216 running under a given subscription 714.

Some embodiments find differences 704 in configuration 702 between identified geo-replicas of the service. When services 216 are replicated across regions, it is usually the case that the different components 212, 214 and their configurations are the same, or at least are expected or assumed to be the same. However, this is not always the case. Subtle differences are sometimes hard to spot and may cause or contribute to performance and stability issues. One of the utilizations 1112 of the clustering and identification of various geos (replicas) of a service is to help find these differences, which can be very critical.

A challenge with comparing different geos is to find a 1:1 mapping between resources 212 of the geos 218, e.g., for configuration and other comparison purposes, which resource of a ResourceGroupA 214 should be compared to which resource of ResourceGroupB.

For instance, assume a service has ten resources in ResourceGroupA and ten resources in ResourceGroupB. To find differences, an embodiment should compare the correct resources from the two resource groups with each other. Matching resources between the groups may be straightforward if all ten resources are of unique types, as the embodiment can then quickly create a 1:1 mapping between the same resource types. But in practice, it is very common to have more than one resource of a given type in a particular resource group. Thus, finding the correct 1:1 mapping 316 is both important and generally not straightforward.

Some embodiments map 1202 various resources between all the geo replicated services in a manner consistent with the following. Fetch a json representation of all resources. In Azure® clouds, for example, this may involve using an Azure® Resource Manager, an Azure® Resource Graph, and an Azure® Application Change Analysis tool, combining fetched results into a unified json data structure. Flatten all the keys of the json for all resources across all resource groups.

Next, create a hashmap of {key: count} for all resources. For example:

ResourceA->[key1: countA1, key2: countA2 . . . keyi, countAi]

ResourceB->[key1: countB1, key2: countB2 . . . keyi, countBi]-

Find cosine similarity of all resources between the two resource groups that are being compared. Do this for every combination of resource group pairs. However, do not compare resources with other resources in the same resource group.

Then do clustering as follows. Create a max-heap of calculated cosine similarity scores. Pop max similar resources—RiA, RjB where Ri belongs to Resource Group A and RjB belongs to Resource Group B from max heap. Check if either of them are part of any clusters already. If no, then combine both to make them one cluster. If RiA is in a cluster, check if that cluster contains any other resource from Resource Group B. If yes, do not do anything, but if no, add RjB to that cluster. If both RiA and RjB are in different clusters, check if both clusters already have representations from one or more common resource groups. If any existing representations are found, do nothing, but if none are found then combine both clusters. In the end, this algorithm will produce all clusters that will contain resources for which a 1:1 comparison can be made, for any kind of analysis, including in particular finding configuration differences.

Some embodiments find differences between corresponding resources identified by the algorithm discussed above. Given the clusters 308, the embodiment knows what resources to compare to find differences. The embodiment can use the Json data fetched per the discussion above. The data may be normalized, based on the data source it was fetched from. After normalization, json diffing tools may be employed to find diffs across all resources, and then the differences can be reported to the user.

As an example of ranking configuration differences, consider the reported data below for a service 216 deployed in over a dozen regions 210. The resource IDs shown here have been truncated for clarity of viewing in this format, and for confidentiality protection.

```
{
  “Score”: 0.8947368,
    “resources[1].properties.typeVersion”: {
    “clusterh37hn.jsonsp-prod-australiaeast-comp-008”: “6.0.20.20200716.6”,
    “cluster3fwbr.jsonsp-prod-southafricanorth-comp-008”: “6.0.20.20200723.4”,
    “clusterstpqr.jsonsp-prod-westeurope-comp-010”: “6.0.20.20200723.4”,
    “cluster5i6y6.jsonsp-prod-brazilsouth-comp-003”: “6.0.20.20200716.6”,
    “clusternvx26.jsonsp-prod-canadacentral-comp-008”: “6.0.20.20200716.6”,
    “clusterwvrg2.jsonsp-prod-centralindia-comp-008”: “6.0.20.20200716.6”,
    “clustergpfeg.jsonsp-prod-centralus-comp-008”: “6.0.20.20200716.6”,
    “clusternnitu.jsonsp-prod-eastasia-comp-002”: “6.0.20.20200716.6”,
    “cluster3oadx.jsonsp-prod-eastus-comp-008”: “6.0.20.20200716.6”,
    “clusterpqmgh.jsonsp-prod-francecentral-comp-008”: “6.0.20.20200716.6”,
    “cluster4uic7.jsonsp-prod-japaneast-comp-008”: “6.0.20.20200716.6”,
    “clusterwp2bg.jsonsp-prod-koreacentral-comp-009”: “6.0.20.20200716.6”,
    “clusterfrvxl.jsonsp-prod-northeurope-comp-008”: “6.0.20.20200716.6”,
    “clusterw2y7x.jsonsp-prod-southcentralus-comp-003”: “6.0.20.20200716.6”,
    “cluster4rhas.jsonsp-prod-southeastasia-comp-008”: “6.0.20.20200716.6”,
    “cluster7mcs4.jsonsp-prod-switzerlandnorth-comp-010”: “6.0.20.20200716.6”,
    “clusterltvm4.jsonsp-prod-uksouth-comp-008”: “6.0.20.20200716.6”,
    “clustertauvn.jsonsp-prod-westcentralus-comp-004”: “6.0.20.20200716.6”,
    “cluster2ejc2.jsonsp-prod-westus2-comp-008”: “6.0.20.20200716.6”
  }
}
```

Each diff may be grouped by the property name, showing the value across all resources for that property. The resources[1].properties.typeVersion property was identified to be different for two of the nineteen regions. The score at the top is calculated as (number of regions with same property value/number of total regions)=17/19=0.89 in this example case.

If an embodiment sorts all diffs on this score, it can show diffs that are probably more important and eliminate 1204 low score diffs like LocationName which will be different for all 19 regions and will hence have a score of 1/19.

Some embodiments take user feedback on the relative importance of differences shown to the user, to increase or decrease a score for particular property changes based on user feedback.

Some embodiments calculate a frequency score for properties across all subscriptions 714 to see which properties are found to be different more rarely than other properties. Then an embodiment may consider a rare difference to be more likely a misconfiguration; there could be some properties which are very commonly different across subscriptions, which may indicate that it is acceptable for that property to be different.

Some embodiments described herein may be viewed by some people in a broader context. For instance, concepts such as correlation, ease, efficiency, scope, or visibility may be deemed relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems, such as how to automatically and proactively provide accurate reports that identify all of a subscription's geo-replicated services 216 and their respective regions 210, resource groups 214, replicas 218, and resources 212. Other configured storage media, systems, and processes involving correlation, ease, efficiency, scope, or visibility are outside the present scope. Accordingly, vagueness, mere abstractness, lack of technical character, and accompanying proof problems are also avoided under a proper understanding of the present disclosure.

### Additional Combinations and Variations

Any of these combinations of code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular motivating examples and scenarios, operating environments, software processes, identifiers, data structures, data formats, notations, control flows, naming conventions, or other implementation choices described herein. Any apparent conflict with any other patent disclosure, even from the owner of the present innovations, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.

ALU: arithmetic and logic unit

API: application program interface

BIOS: basic input/output system

CD: compact disc

CPU: central processing unit

DVD: digital versatile disk or digital video disc

FPGA: field-programmable gate array

FPU: floating point processing unit

GDPR: General Data Protection Regulation

GPU: graphical processing unit

GUI: graphical user interface

IaaS or IAAS: infrastructure-as-a-service

ID: identification or identity

IP: internet protocol

JSON: JavaScript object notation (JavaScript® is a mark of Oracle America, Inc.).

LAN: local area network

OS: operating system

PaaS or PAAS: platform-as-a-service

RAM: random access memory

ROM: read only memory

TCP: transmission control protocol

TPU: tensor processing unit

UEFI: Unified Extensible Firmware Interface

URL: uniform resource locator

VM: virtual machine

WAN: wide area network

XML: extensible markup language

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

As used herein, a “computer system” (a.k.a. “computing system”) may include, for example, one or more servers, motherboards, processing nodes, laptops, tablets, personal computers (portable or not), personal digital assistants, smartphones, smartwatches, smartbands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” means a consumable program offering, in a cloud computing environment or other network or computing system environment, which provides resources to multiple programs or provides resource access to multiple programs, or does both. In general in industry, it is not necessarily assumed that a given service is geo-replicated, but all services discussed here as an object of analysis or investigation are presumed to be geo-replicated, and any service expressly referenced by numeral 216 is understood to be geo-replicated.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write).

“Region” means region or availability zone or both. Some cloud service providers (including Microsoft and Amazon) distinguish between a region and an availability zone, with availability zones being located within generally larger regions. However, teachings herein may be applied to availability zones as well as to regions. So the term “region” in the claims should be understood to refer to a region in the industry sense or an availability zone in the industry sense, or to both (e.g., a geo-replicated service may have a replica in availability zone 1 of region X, another replica in availability zone 2 of region X, and another replica in region Y). This allows the claims and most of the specification to avoid awkward language constructions involving “region or availability zone or both” by simply reciting “region” instead, with the understanding that “region or availability zone or both” is meant.

“Access” to a computational resource includes use of a permission or other capability to read, modify, write, execute, or otherwise utilize the resource. Attempted access may be explicitly distinguished from actual access, but “access” without the “attempted” qualifier includes both attempted access and access actually performed or provided.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment. Geo-replicated service management operations such as creating or comparing vectors 306, producing clusters 308, forming digital associations 310, mapping 1202 cloud resources, and many other operations discussed herein, are understood to be inherently digital. A human mind cannot interface directly with a CPU or other processor, or with RAM or other digital storage, to read and write the necessary data to perform the geo-replicated service management steps taught herein. This would all be well understood by persons of skill in the art in view of the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

Throughout this document, use of the optional plural “(s)”, “(es)”, or “(ies)” means that one or more of the indicated features is present. For example, “processor(s)” means “one or more processors” or equivalently “at least one processor”.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this innovation disclosure discusses various data values and data structures, and recognize that such items reside in a memory (RAM, disk, etc.), thereby configuring the memory. One of skill will also recognize that this innovation disclosure discusses various algorithmic steps which are to be embodied in executable code in a given implementation, and that such code also resides in memory, and that it effectively configures any general purpose processor which executes it, thereby transforming it from a general purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as agglomerating, ascertaining, associating, calculating, checking, clusterizing (aka clustering), diffing, documenting, forming, identifying, mapping, modifying, supplying, suspending, testing, updating, using utilizing, vectorizing, (and agglomerate, agglomerated, ascertain, ascertained, etc.) with regard to a destination or other subject may involve intervening action such as the foregoing or forwarding, copying, uploading, downloading, encoding, decoding, compressing, decompressing, encrypting, decrypting, authenticating, invoking, and so on by some other party, including any action recited in this document, yet still be understood as being performed directly by the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### LIST OF REFERENCE NUMERALS

The following list is provided for convenience and in support of the drawing figures and as part of the text of the specification, which describe innovations by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:

100 operating environment, also referred to as computing environment

102 computer system, also referred to as a “computational system” or “computing system”, and when in a network may be referred to as a “node”

104 users, e.g., an analyst or other user of an enhanced system 202

106 peripherals

108 network generally, including, e.g., clouds, local area networks (LANs), wide area networks (WANs), client-server networks, or networks which have at least one trust domain enforced by a domain controller, and other wired or wireless networks; these network categories may overlap, e.g., a LAN may have a domain controller and also operate as a client-server network

110 processor

112 computer-readable storage medium, e.g., RAM, hard disks

114 removable configured computer-readable storage medium

116 instructions executable with processor; may be on removable storage media or in other memory (volatile or non-volatile or both)

118 data

120 kernel(s), e.g., operating system(s), BIOS, UEFI, device drivers

122 tools, e.g., anti-virus software, firewalls, packet sniffer software, intrusion detection systems, intrusion prevention systems, other cybersecurity tools, debuggers, profilers, compilers, interpreters, decompilers, assemblers, disassemblers, source code editors, autocompletion software, simulators, fuzzers, repository access tools, version control tools, optimizers, collaboration tools, other software development tools and tool suites (including, e.g., integrated development environments), hardware development tools and tool suites, diagnostics, browsers, and so on

124 applications, e.g., word processors, web browsers, spreadsheets, games, email tools, commands

126 display screens, also referred to as “displays”

128 computing hardware not otherwise associated with a reference number 106, 108, 110, 112, 114

202 enhanced computing system, e.g., one or more computers 102 enhanced with geo-replicated service management functionality, or computers which perform a method 1100 or 1200 or one or more of steps 400, 1104, 1108, 1202

204 geo-replicated service management functionality, e.g., functionality which does at least one of the following: performs one or more of steps 400, 1104, 1108, 1202, conforms with the FIG. 12 flowchart or its constituent flowchart 1100, or otherwise provides capabilities first taught herein

206 service management tool, e.g., software which does any of the following: reduces a service operational cost, reduces a service security risk, improves a service configuration consistency, debugs a service deficiency, documents a service implementation, modifies a service resource allocation, modifies a service regions span, suspends a service, deploys a service, updates a service, or tests a service

208 cloud

210 cloud region or availability zone

212 digital cloud resource

214 cloud resource group, pod, set, or other collection of one or more cloud resources distinguished from other cloud resources of the same subscriber

216 geo-replicated cloud service

218 digital replica of a geo-replicated cloud service; typically a replica consists of or owns one resource group 214

302 one or more associations 310, error or status codes, or other computational result of operation(s) performed by GRSM software

304 GRSM software, e.g., software which performs one or more of steps 400, 1104, 1108, 1202, conforms with the FIG. 12 flowchart or its constituent flowchart 1100, or otherwise provides capabilities first taught herein

306 digital vector representing a resource group 214 in a vector space 314, e.g., a tuple of feature 312 values

308 digital cluster of vectors 306, representing a cluster of resource groups 214, and thus a cluster of replicas 218

310

[symbol]

312 vector feature

314 vector space, e.g., a set of definitions of vector features 312 plus a metric 404 definition

316 map which correlates resources across regions; also referred to as a “mapping” or a “resource mapping” (noun)

318 interface generally, e.g., API, network connection, or other mechanism for transferring data in a computing system 102

400 clustering, also referred to, e.g., as “clusterizing” or “producing clusters”; may include operations which measure distances between vectors using a metric and define sets of close vectors as clusters

402 hierarchical agglomerative clustering; an example of clustering 400

404 metric for calculating distance between vectors that represent resource groups; may be used in clustering 400 or mapping 1202

406 K-means clustering; an example of clustering 400

408 parameter used in K-means clustering which specifies the number of clusters to produce

410 operation of receiving a parameter 408, e.g., via a GUI or other interface 318

502 resource type, e.g., virtual machine, database, particular kind of database, virtual network, etc.

504 presence indication of a resource of a given type 502 in a resource group, e.g., whether virtual machines are present; a presence indication of a given type may be implemented, e.g., as a Boolean whose value indicates whether the type is present, or it may be implemented by code which executes differently when the type is present than when the type is not present

506 resource property

508 presence indication of a resource property 506, e.g., whether virtual machine memory size is present as a key value or other property, or whether a virtual net property is present indicating use of a virtual network; a presence indication of a given property may be implemented, e.g., as a Boolean whose value indicates whether the property is present, or it may be implemented by code which executes differently when the property is present than when the property is not present

510 resource property value, e.g., VM memory size

512 count of distinct types of resources in a resource group, e.g., 2 when only VMs and a firewall are present

514 resource type similarity

516 resource group tag, e.g., “production” or “version 7”

518 resource group tag similarity

520 weight given to a similarity when mapping resources

522 resource group name, e.g., “user photo postings database”

524 resource group name similarity

526 resource digital description, e.g., a data structure or text or both which define a resource

528 resource group digital description, e.g., a data structure or text or both which define a resource group

530 resource property similarity

602 data serialization language, e.g., XML

604 resource version, e.g., “version 7” or “production” or “6.0.20.20200716.6”

606 data serialization structure, e.g., a JavaScript Object Notation (JSON) structure

608 operational cost, e.g., processor time, memory size, bandwidth, I/O operations, etc.

610 memory allocation; note that “memory” includes volatile memory or nonvolatile memory or both unless otherwise stated

702 resource or resource group configuration, e.g., default settings, user-defined settings, allocations, types, and versions

704 consistency or difference of one configuration relative to another configuration 702

706 security risk, e.g., a risk to data confidentiality, data availability, data integrity, privacy, or regulatory compliance

708 service 216 span, e.g., which availability zones or other regions the service has a replica in

710 implementation of a service, e.g., particular configuration(s) 702, particular span 708, service APIs, metadata such as service name

712 service 216 deficiency or proficiency, e.g., performance level, cost, bug, allocation, or span

714 subscription, subscriber, tenant, or other manager or owner of cloud resource, cloud resource group, or service 216

1100 flowchart; 1100 also refers to geo-replicated service management methods illustrated by or consistent with the FIG. 11 flowchart

1102 computationally identify resource groups; depending on the cloud, a list of resource groups may be maintained by a resource manager or other cloud infrastructure and may be accessible through an API to an authorized subscription user, or resource groups may be identified by traversing a list of the subscriber's resources and gathering resource group IDs, for example

1104 vectorize resource groups; also referred to as “creating vectors” or “representing” or “defining” resource groups as vectors; performed computationally, e.g., by extracting feature 312 values from resource group data structures into vector data structures

1108 associate services 216 to clusters 308, thereby forming or updating an association 310; performed computationally, e.g., by populating a data structure which includes both a service 216 name or other identifier and a cluster 308 name or other identifier such that the resources 212 in the cluster are known to belong to the service 216

1110 computationally supply association(s) 310 to one or more tools 206, e.g., through an API or network transmission or both

1112 computationally utilize association(s) 310 in or by a tool 206

1200 flowchart; 1200 also refers to geo-replicated service management methods illustrated by or consistent with the FIG. 12 flowchart (which incorporates the steps of FIG. 11)

1202 computationally perform cross-regional resource-to-resource mapping; also referred to simply as “mapping”; may also be considered secondary clustering or quasi-clustering; creates a map 316

1204 avoid employing location-dependent data in a metric

1206 location-dependency, data that is location-dependent, e.g., resource names that include a region ID or other location identifier

1208 reduce operational cost

1210 reduce security risk

1214 improve configuration consistency, e.g., by reducing metric 404 distance between two or more configurations 702

1216 debug code or configuration problems

1218 modify an aspect of a service 216

1220 deploy part or all of a service 216; performed computationally

1222 update part or all of a service 216; performed computationally

1224 test part or all of a service 216; performed computationally

1226 suspend execution of part or all of a service 216; performed computationally

1228 document part or all of a service 216

1230 use machine learning (supervised or unsupervised)

1232 unsupervised machine learning (noun); computationally perform unsupervised machine learning

1234 ascertain a cost 608

1236 check a configuration 702 against a template or goal or another configuration

1238 any step discussed in the present disclosure that has not been assigned some other reference numeral

### CONCLUSION

In short, the teachings herein provide a variety of geo-replicated service management functionalities 204 which operate in enhanced systems 202. Embodiments automatically identify 1100 which cloud resources 212 and resource groups 214 correspond to which geo-replicated services 216 and service replicas 218. Resource groups 214 are represented 1104 as vectors 306 having features 312 which may depend on resource types 502, resource group tags 516, resource group names 522, and other data 506, 510, 526, 528. Vectors 306 are clustered 400 using hierarchical agglomerative clustering 402 or k-means clustering 406, for example, and each cluster 308 is recognized 1108 as corresponding to a service 216. Associations 310 between resources 212 and services 216 are then used 1112 for management functions such as updating 1222 or testing 1224 or suspending 1226 or modifying 1218 only the resources 212 of a given service 216, finding 1236 configuration 701 inconsistencies 704, or identifying 1234 higher cost 608 replicas 218. Because two replicas 218 of a given service 216 may have different resource configurations 702 or different constituent resources 212, similarity measures 404, 514, 518, 524, 530 may be employed to map 1202 resources 212 between replicas 218 when defining 1104 resource group 214 vectors 306 or analyzing replicas 218. Automation 1200 permits documentation 1228 of accurate current associations 310 between resources 212 and services 216, even when resources 212 are being created or deleted automatically in a cloud 208.

Embodiments are understood to also themselves include or benefit from tested and appropriate security controls and privacy controls such as the General Data Protection Regulation (GDPR). Use of the tools and techniques taught herein is compatible with use of such controls.

Although Microsoft technology is used in some motivating examples, the teachings herein are not limited to use in technology supplied or administered by Microsoft. Under a suitable license, for example, the present teachings could be embodied in software or services provided by other vendors.

Although particular embodiments are expressly illustrated and described herein as processes, as configured storage media, or as systems, it will be appreciated that discussion of one type of embodiment also generally extends to other embodiment types. For instance, the descriptions of processes in connection with FIGS. 11 and 12 also help describe configured storage media, and help describe the technical effects and operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds or ranges, specific architectures, specific attributes, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A computing system configured for geo-replicated service management, the system comprising:
a digital memory;
a processor in operable communication with the digital memory, the processor configured to perform geo-replicated service management steps which include (a) identifying at least one resource group in each of a plurality of cloud regions, each resource group including at least one cloud resource, (b) representing each resource group as a vector in a predefined feature vector space, (c) clustering similar resource group vectors by use of unsupervised machine learning, thereby producing clusters which span cloud regions, each cluster containing at least one resource group vector, (d) forming digital associations which associate geo-replicated services with clusters, and (e) supplying the digital associations to a service management tool, thereby supporting effective management of at least one geo-replicated service whose respective cloud resources were not previously expressly identified as belonging to that geo-replicated service.

2. The system of claim 1, wherein the predefined feature vector space comprises at least one of the following features:
a presence indication of a resource of a given type in a resource group;
a presence indication of a resource property;
a resource property value;
a count of distinct types of resources in a resource group;
a resource group tag;
a resource group name; or
a resource description or a resource group description.

3. The system of claim 1, wherein the at least one cloud resource is represented digitally in the system by at least one of the following:
a data serialization language; or
a data serialization structure.

4. The system of claim 1, wherein the digital associations associate geo-replicated services with clusters such that each cluster includes at most one resource group per region.

5. The system of claim 1, wherein the digital associations associate geo-replicated services with clusters such that each cluster corresponds to exactly one geo-replicated service, and wherein the system is free of any geo-replicated service which has been expressly identified as a geo-replicated service on a display of the system and which has no associated cluster.

6. A method for managing geo-replicated services in one or more clouds, the method comprising:
identifying at least one resource group in each of a plurality of cloud regions, each resource group including at least one cloud resource;
automatically representing each resource group as a digital vector in a predefined feature vector space;
automatically clustering similar resource group vectors by use of unsupervised machine learning, thereby producing clusters which span cloud regions, each cluster containing at least one resource group vector;
automatically forming digital associations which associate geo-replicated services with clusters; and
utilizing at least one of the digital associations to manage at least one geo-replicated service.

7. The method of claim 6, wherein utilizing at least one of the digital associations to manage at least one geo-replicated service comprises at least one of the following:
reducing a service operational cost;
reducing a service security risk;
improving a service configuration consistency;
debugging a service deficiency;
documenting a service implementation;
modifying a service resource allocation;
modifying a service regions span;
suspending a service;
deploying a service;
updating a service; or
testing a service.

8. The method of claim 6, further comprising mapping from a resource of a service in one region to another resource of the service in another region.

9. The method of claim 6, wherein automatically clustering similar resource group vectors by use of unsupervised machine learning comprises hierarchical agglomerative clustering.

10. The method of claim 6, further comprising getting a target number of services, and wherein automatically clustering similar resource group vectors by use of unsupervised machine learning comprises K-means clustering with a parameter K that equals the target number of services.

11. The method of claim 6, further comprising mapping from a resource of a service in one region to another resource of the service in another region, wherein the mapping avoids reliance on any location-dependent resource property or location-dependent resource property value.

12. The method of claim 6, further comprising mapping from a resource of a service in one region to another resource of the service in another region, wherein the mapping depends on at least one of the following:
a computed measure of similarity between resource types;
a computed measure of similarity between resource properties; or
a computed measure of similarity between resource group names.

13. The method of claim 6, wherein the digital associations associate geo-replicated services with clusters such that at least one cluster includes more than one resource group in at least one region.

14. The method of claim 6, wherein utilizing at least one of the digital associations to manage at least one geo-replicated service comprises at least one of the following:
ascertaining a service operational cost; or
checking a service configuration.

15. The method of claim 6, further comprising testing at least one digital association for accuracy.

16. A computer-readable storage medium configured with data and instructions which upon execution by a processor cause a computing system to perform a method for managing geo-replicated services in one or more clouds, the method comprising:
identifying a resource group in each of a plurality of cloud regions, each resource group including a plurality of cloud resources;
automatically representing each resource group as a digital vector in a predefined feature vector space;
automatically clustering similar resource group vectors, thereby producing a cluster which spans at least two cloud regions, the cluster containing at least two resource group vectors;
automatically forming a digital association which associates a geo-replicated service with the cluster; and
utilizing the digital association to manage the geo-replicated service.

17. The computer-readable storage medium of claim 16, wherein the method further comprises mapping from a resource of a service in one region to another resource of the service in another region.

18. The computer-readable storage medium of claim 17, wherein the mapping documents a configuration difference between two or more replicas of the geo-replicated service, each replica corresponding to a respective resource group whose resources are mapped by the mapping.

19. The computer-readable storage medium of claim 16, wherein the clustering depends on at least a computed measure of similarity between vectors having features which include at least a resource type dependent feature and a resource group tag dependent feature.

20. The computer-readable storage medium of claim 19, wherein the computed measure of similarity between vectors gives greater weight to the resource type dependent feature than to the resource group tag dependent feature.
